(19) United States
(12) Patent Application Publication
(10) Pub. No.: US 2015/0292625 A1
(43) Pub. Date: Oct. 15, 2015

(54) CONTROL VALVE FOR A HYDRAULIC DEVICE WITH A REPLACEABLE HYDRAULICS UNIT

(71) Applicant: SCHAEFFLER TECHNOLOGIES AG & CO. KG, Herzogenaurach (DE)

(72) Inventors: David Kohler, Egloffstein (DE); Jens Hoppe, Erlangen (DE); Markus Kinscher, Lauf a.d. Pegnitz (DE); Ali Bayrakdar, Rothenbach/Pegnitz (DE)

(73) Assignee: Schaeffler Technologies AG & Co. KG, Herzogenaurach (DE)

(21) Appl. No.: 14/442,768

(22) PCT Filed: Sep. 6, 2013
(86) PCT No.: PCT/DE2013/200158

§ 371 Date: May 14, 2015

(30) Foreign Application Priority Data
Nov. 15, 2012 (DE) 10 2012 220 830.5

(51) Int. Cl. F16K 1/00

(52) U.S. Cl. CPC F16K 1/00

(57) ABSTRACT

A control valve (1) for a hydraulic device, particularly a central valve of a camshaft adjuster for reciprocating internal combustion engines, with a receiving part (8) in which a hydraulic unit (2) with a control piston (5) is arranged, wherein the control piston (5) is moveably housed in the hydraulic unit (2), is loaded by a spring (6) and can be limited in its displacement movement by a stop element (7), and with a retaining ring (9) that can be fixed in an inner housing (12) to the receiving part (8) and wherein the stop element (7) is designed as a separate component and can be connected to the hydraulic unit (2) by a material-fit or positive-fit connection.

### FIELD OF THE INVENTION

The invention relates to a control valve for a hydraulic device, especially a central valve of a camshaft adjuster for reciprocating internal combustion engines, with a receiving part in which a hydraulic unit with a control piston is arranged, wherein the control piston can be displaced in the hydraulic unit, is loaded on one side by a spring and is supported on the other side so that it is limited in its displacement movement by means of a stop element, and with a locking ring that can be fixed in an interior receptacle on the receiving part.

### BACKGROUND

A corresponding control valve is known from DE 10 2009 039 385 A1. In this construction, the receiving part is constructed as a camshaft and the hydraulic unit is inserted there. The hydraulic unit is supported on the inner end of the camshaft on one section and is fixed on the outer end by means of a locking ring that engages in an interior receptacle of the camshaft. On its inner periphery, the locking ring has tabs that extend up to a section on the control piston, so that this piston can be supported on the locking ring against the force of the spring. Furthermore, on the hydraulic unit, positive-locking elements are formed that surround the locking ring from the inside, so that the hydraulic unit is formed as an assembly and can be inserted or removed for assembly or disassembly in the receiving part, in this case, in the camshaft. The inner tabs on the locking ring and the positive-locking elements on the hydraulic unit here also hold the assembly together against the force of the spring.

These desired measures are associated with high structural costs, because the positive-locking elements that are installed as individual parts or on the hydraulic unit are complicated in production and in assembly.

Because the locking ring must be stretched greatly to move it in and out from the positive-locking elements, there is the problem that it loses tension or breaks.

The design of the tensioning force of the locking ring is also difficult, because it must have sufficient tensioning force, on one hand, to be able to engage in the interior receptacle of the camshaft, but, on the other hand, the tensioning force must not be too high, because it must form the stop for the control piston and must not expand too much.

### SUMMARY

The objective of the invention is to eliminate the disadvantages described above and to modify the control valve so that an assembly is provided with low structural costs and thus is economical to produce and can be installed and removed easily as one unit in the receiving part.

The objective of the invention is met in that the stop element is constructed as a separate part and can be connected to the hydraulic unit with a material-fit or positive-fit connection. Through this construction it is achieved that, independent of the locking ring, the control piston can be fixed in the hydraulic unit, so that the hydraulic unit can be installed and removed as one unit after removing the locking ring.

In a hydraulic unit that has a valve housing made from plastic and a control sleeve, it is simple to fix the stop element on the valve housing. It can be connected with a material-fit connection to the valve housing, wherein a welding process, in particular, an ultrasonic welding, is possible, because the stop element or elements are also advantageously made from plastic. The valve housing can be made as a plastic sleeve, wherein this is mounted on the control sleeve, e.g., by adhesion. The plastic sleeve, however, can also be injection molded onto the control sleeve, wherein simultaneously a mounting is created. The stop element can have several individual stops that are fastened individually on the plastic sleeve, for example, distributed around the periphery.

In another construction of the invention, it is proposed that the stop element is constructed as a ring, advantageously made from plastic, so that a surrounding material-fit connection is possible. The radial extent of the ring can correspond approximately to the thickness of the plastic sleeve and can limit the excursion travel of the control piston with inward projecting tabs.

It is also possible to fasten the stop element or the ring on the valve housing, that is, the plastic sleeve, by means of at least one snap-on connection. This is the mentioned positive-locking connection that could also be realized by means of hooks on the plastic sleeve or on the stop element or ring.

In another construction of the invention it is provided that the stop element has at least one guide unit for the locking ring. This could be an outer groove for holding the locking ring, so that the locking ring does not have to be installed and removed individually, but forms one unit with the structural unit of the hydraulic unit.

To guarantee simple actuation of the locking ring in the outer groove of the ring, the ring has at least one cutout in which the ring eyelets of the locking ring are supported, so that these can be engaged from the outside by means of a tool.

Instead of the outer groove, the stop element or the ring could also have snap hooks for holding the locking ring.

### BRIEF DESCRIPTION OF THE DRAWINGS

For further explanation of the invention, reference will be made to drawings in which embodiments of the invention are shown in a simplified manner.

Shown are:

FIG. 1: a cross section through a control valve,

FIG. 2: a cutout from the hydraulic unit of the control valve at an enlarged scale,

FIG. 3: a top view of the hydraulic unit according to FIG. 2,

FIG. 4: a cutout from the hydraulic unit according to FIG. 2 in modified construction,

FIG. 5: a top view of the hydraulic unit according to FIG. 4,

FIG. 6: a cutout from the hydraulic unit in additionally modified construction,

FIG. 7: a top view of the hydraulic unit according to FIG. 6,

FIG. 8: a cutout from the hydraulic unit with additionally modified construction, and

FIG. 9: a top view of the hydraulic unit according to FIG. 8.

### DETAILED DESCRIPTION OF THE PREFERRED EMBODIMENTS

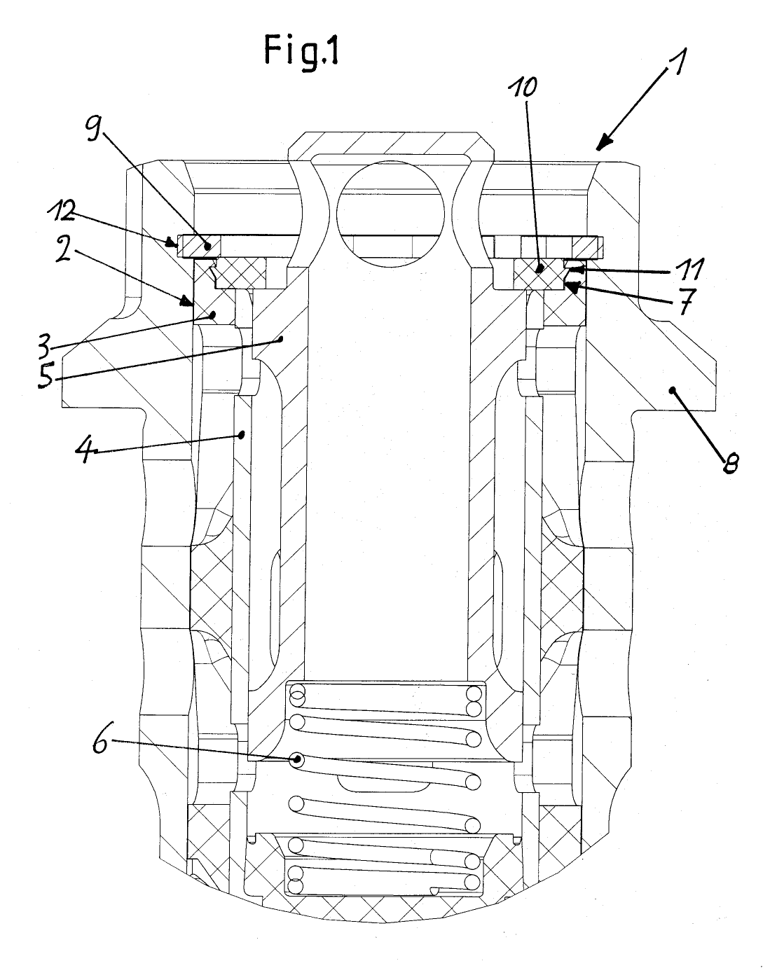

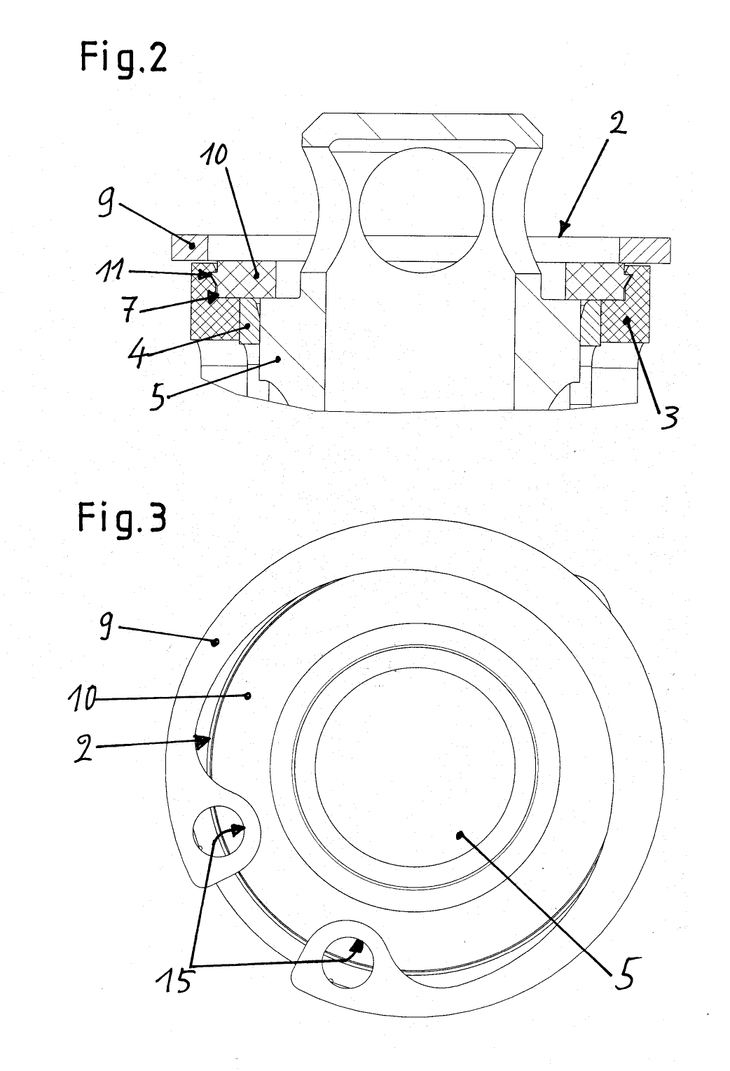

In FIGS. 1 to 9, as far as shown in detail, 1 designates a control valve in general, in which a hydraulic unit designated with 2 in general is installed. The hydraulic unit 2 has a valve housing 3 constructed as a plastic sleeve in which a control sleeve 4 is supported. The valve housing 3 is advantageously formed on the control sleeve 4 as an insert-molded part. A control piston 5 that is loaded on one side by a spring 6 and is limited on the other side by a stop element designated in general with 7 is guided in the control sleeve 4 so that it can move axially. The hydraulic unit 2 is inserted in a receptacle unit 8 and fixed in the receiving part 8 by means of a locking ring 9.

According to FIGS. 1 to 3, the stop element 7 is constructed as a ring 10 that is inserted and fixed in the valve housing 3 by means of a snap-on connection 11. The inner diameter of the ring 10 is less than the outer diameter of the control piston 5, so that the ring 10 defines an axial fixing of the control piston 5 in the hydraulic unit 2. The ring 10 can be made from any material, at least if the valve housing is made from plastic, because the snap-on connection is also effective if the ring 10 is made from a metallic material.

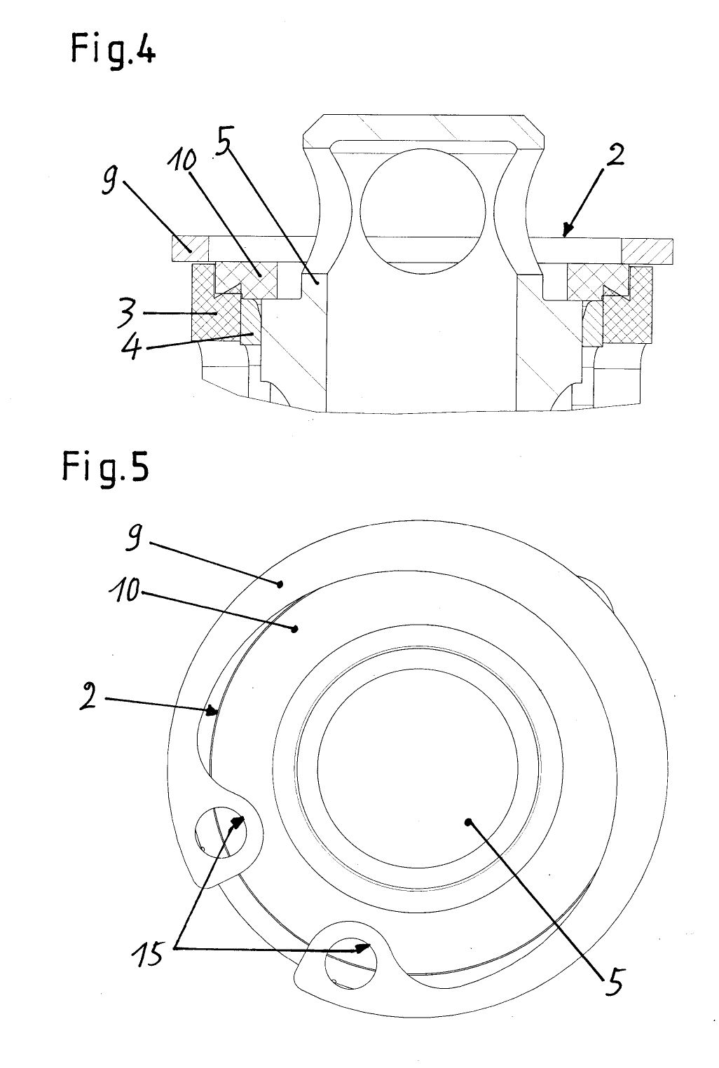

In FIGS. 4 and 5, the stop element 7 is constructed as a plastic ring that is mounted on the valve housing by means of a suitable welding process. An ultrasonic welding process is possible here.

As can be seen in FIGS. 1 to 5, the locking ring 9 is constructed as a separate part. After locking the locking ring 9 in an interior receptacle 12 in the receiving part 8, the hydraulic unit 2 is secured as an assembly. Here it must be made note of that the locking ring 9 is not secured during assembly and disassembly and therefore could spring out or fall out.

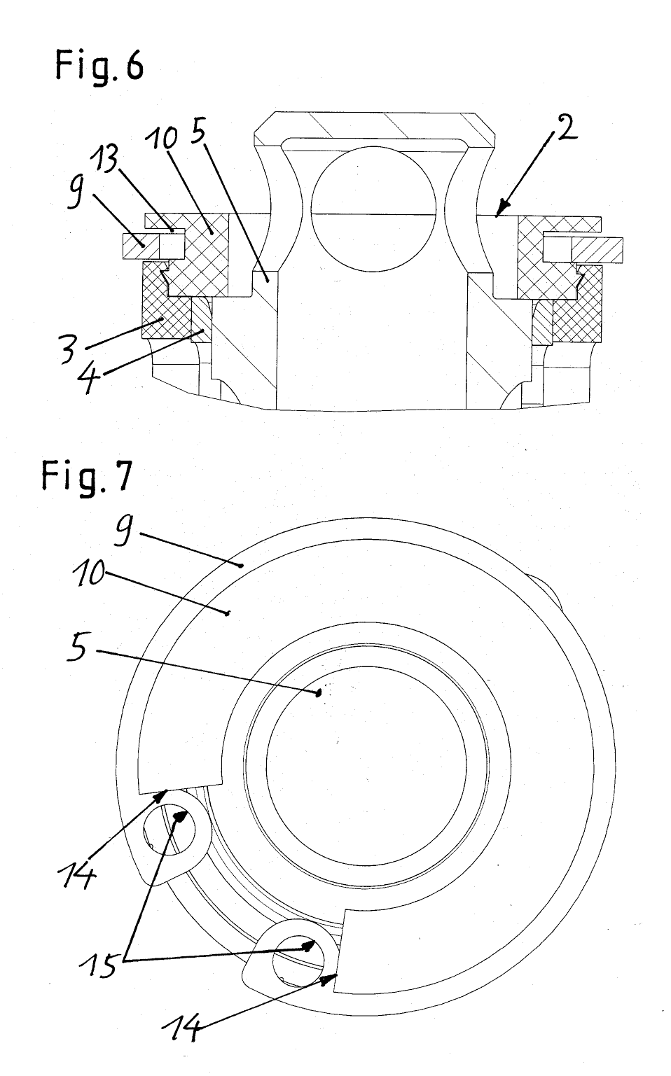

Therefore, in FIGS. 6 and 7, the ring 10 is modified so that it has an outer groove 13 in which the locking ring 9 is inserted so that it is fixed on the ring 10. According to these figures, the ring 10 has a cutout 14 that passes through the ring 10. The cutout 14 is advantageous, on one hand, for being able to set a matching tool on ring eyelets 15 of the locking ring 9 and, on the other hand, for enabling simpler insertion of the locking ring 9 in the outer groove 13 of the ring 10, because the ring 10 can be easily deformed due to the cutout 14, especially if it is made from plastic.

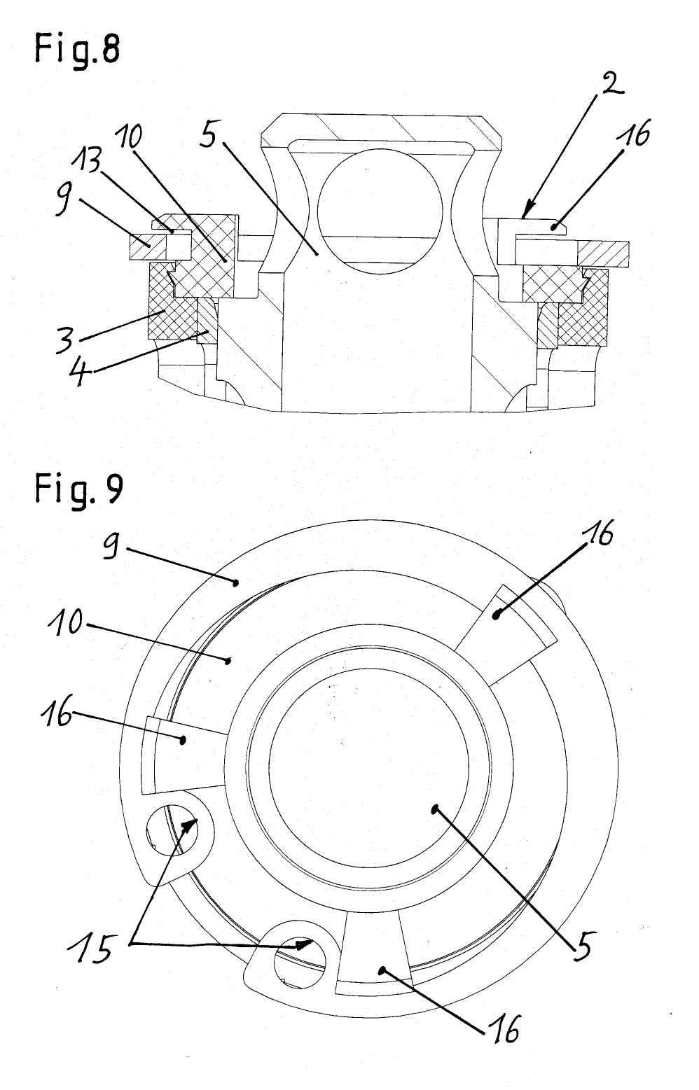

In the embodiment according to FIGS. 8 and 9, the ring 10 has hooks 16 behind which the locking ring 9 can be fixed. This makes the assembly of the locking ring 9 on the ring 10 even easier.

### LIST OF REFERENCE NUMBERS

1 Control valve
2 Hydraulic unit
3 Valve housing
4 Control sleeve
5 Control piston
6 Spring
7 Stop element
8 Receiving part
9 Locking ring
10 Ring
11 Snap-on connection
12 Interior receptacle
13 Outer groove
14 Cutout
15 Ring eyelet
16 Hook

1. A control valve for a hydraulic device, comprising a receiving part in which a hydraulic unit with a control piston is arranged, the control piston is supported in the hydraulic unit so that it is displaceable, is loaded on one side by a spring, and is supported on the other side so that it is limited in a displacement movement thereof by a stop element, and a locking ring that is fixable in an interior receptacle on the receiving part, the stop element is constructed as a separate component and is connectable to the hydraulic unit with a material-fit or positive-fit connection.

2. The control valve according to claim 1, wherein the hydraulic unit has a valve housing made from plastic and a control sleeve, the stop element is fixed on the valve housing.

3. The control valve according to claim 1, wherein the stop element is connectable to the valve housing by a welding process.

4. The control valve according to claim 1, wherein the stop element has several individual stops.

5. The control valve according to claim 1, wherein the stop element is constructed as a ring.

6. The control valve according to claim 5, wherein the ring is connected to the valve housing by at least one snap-on connection.

7. The control valve according to claim 1, wherein the stop element has at least one guide unit for the locking ring.

8. The control valve according to claim 7, wherein the ring contains an outer groove for holding the locking ring.

9. The control valve according to claim 8, wherein the ring has a cutout in which ring eyelets of the locking ring are supportable.

10. The control valve according to claim 7, wherein the stop element has hooks for holding the locking ring.

11. The control valve of claim 1, wherein the control valve is a control value of a camshaft adjuster for a reciprocating internal combustion engine.
